(19) United States
(12) Patent Application Publication
(10) Pub. No.: US 2004/0005186 A1
(43) Pub. Date: Jan. 8, 2004

(54) Container for attaching to a measuring implement and method of use therefor

(75) Inventors: Kanna Ueda, Higashinada-Ku (JP); Satoshi Yamane, Ashiya Hyogo (JP)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/614,913

(22) Filed: Jul. 8, 2003

Related U.S. Application Data
(60) Provisional application No. 60/394,380, filed on Jul. 8, 2002.

(51) Int. Cl. B43K 7/03

(52) U.S. Cl. 401/194; 401/209

(57) ABSTRACT

A container for attaching to a measuring implement, especially a measuring cap, and for applying a cleaning composition to a surface has an applicator, a hollow body member operatively joined to the applicator, and an attachment portion joined to the hollow body member. The attachment portion removably attaches to the measuring implement. When the applicator is in a dispensing position and when the hollow body contains a cleaning composition therein, the cleaning composition may be dispensed onto the surface via the applicator.

### CROSS REFERENCE TO RELATED APPLICATION

This application claims the benefit of U.S. Provisional Application No. 60/394,380, filed Jul. 9, 2002.

### FIELD OF INVENTION

The present invention relates to a container. Specifically, the present invention relates to a container for applying a cleaning composition to a surface.

### BACKGROUND OF THE INVENTION

Devices, such as brushes, ball-type applicators, nozzles, sprayers, etc., for applying a cleaning composition to a surface, especially for the purpose of pretreating a spot or a stain, are known and have been available for many years. However, such devices may be difficult to clean, and/or may require that additional cleaning composition be used for pretreating, in addition to that used to wash the surface to be cleaned. For example, a pre-treatment device may deliver 5 mL of a viscous liquid detergent to pre-treat a stain, but in some cases, an additional 2-3 mL may stick to the side of the device during the application step. This additional liquid then needs to be rinsed off of the device, and/or added to the surface to prevent waste and reduce messiness.

In addition, if the surface to be cleaned is merely a small part of the total items to be cleaned, additional cleaning composition will typically be used, whether or not it is really needed. For example, if a typical load of laundry requires 50 mL of liquid detergent and if pretreating a spot on a shirt in that load requires 5 mL of liquid detergent, very few individuals will add only 45 mL to the laundry load after pretreating the spot. Instead, most individuals will pretreat the spot with 5 mL and then add 50 mL into the laundry liquor to which the shirt and other items are added. This leads to a situation where the laundry detergent is overdosed by 5 mL, or 10%.

Other measuring implements, typically a measuring cap for liquid detergents, are known which directly incorporate an applicator such as a brush. However these suffer from the drawback that the applicator may not be cleaned easily, or if it is, the measuring cap is not usable until after it is specifically cleaned. Thus, for example, a measuring cap with an attached brush may be washed, but the bottle must be left uncovered, and may not be stored until the measuring cap is replaced.

While separate measuring caps and application devices are known, such application devices are not connected to the application device during use. It is believed that this can substantially increase the potential for messiness and spilling as the cleaning composition is transferred back-and forth.

Accordingly, the need exists for a device which is useful to apply a cleaning composition to a surface, and which still allows the cleaning composition to be quickly stored. In addition, the need exists for a device, especially a pretreating device which encourages accurate cleaning composition dosing, and especially liquid detergent dosing.

### SUMMARY OF THE INVENTION

The present invention relates to a container for attaching to a measuring implement, especially a measuring cap, and for applying a cleaning composition to a surface. The container has an applicator, a hollow body member operatively joined to the applicator, and an attachment portion joined to the hollow body member. The attachment portion removably attaches to the measuring implement. When the applicator is in a dispensing position and when the hollow body contains a cleaning composition therein, the cleaning composition may be dispensed onto the surface via the applicator.

The present invention also relates to a cleaning kit containing such a container as well as a detergent container with a detergent composition, and a measuring implement.

It has now been found that the container herein can both provide accurate application of a cleaning composition to a surface, and also provide accurate dosing of the cleaning composition. Furthermore, the container may pretreat a surface and/or stain while it is attached to the measuring implement. In addition, the container is easy to clean by adding to the wash after use, while the measuring cap, may be replaced onto the cleaning composition bottle to prevent spillage. This also allows the cleaning composition bottle to be stored immediately after use, instead of having to wait until the cleaning load is finished. In addition, it has been found that invention herein significantly reduces messiness during the application and direct application of a cleaning composition to a surface, as less pouring of the cleaning composition back and forth is needed, since the attachment portion attaches to the measuring implement.

All documents cited are, in relevant part, incorporated herein by reference; the citation of any document is not to be construed as an admission that it is prior art with respect to the present invention.

### BRIEF DESCRIPTION OF THE DRAWINGS

While the specification concludes with claims particularly pointing out and distinctly claiming the invention, it is believed that the invention will be better understood from the following description of the accompanying figures in which like reference numerals identify like elements, and wherein:

FIG. 1 is a top perspective view of a preferred embodiment of the container;

FIG. 2 is a cut-away view of the container of FIG. 1, as seen along line 2-2, further including an attached measuring cap;

FIG. 3 is side view of a preferred embodiment of the container with an applicator cover; and

FIG. 4 is a side view of a preferred detergent container and measuring implement.

### DETAILED DESCRIPTION OF THE INVENTION

All percentages, ratios and proportions herein are by weight, unless otherwise specified. All temperatures are in degrees Celsius (° C.) unless otherwise specified. The figures herein are not necessarily drawn to scale.

As used herein, the term “comprising” means that other steps, ingredients, elements, etc. which do not affect the end result can be added. This term encompasses the terms “consisting of” and “consisting essentially of”.

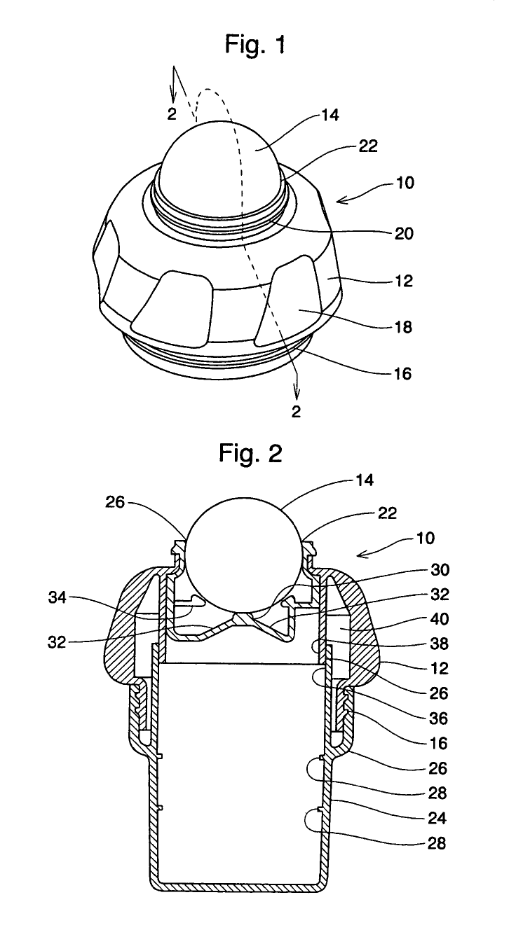

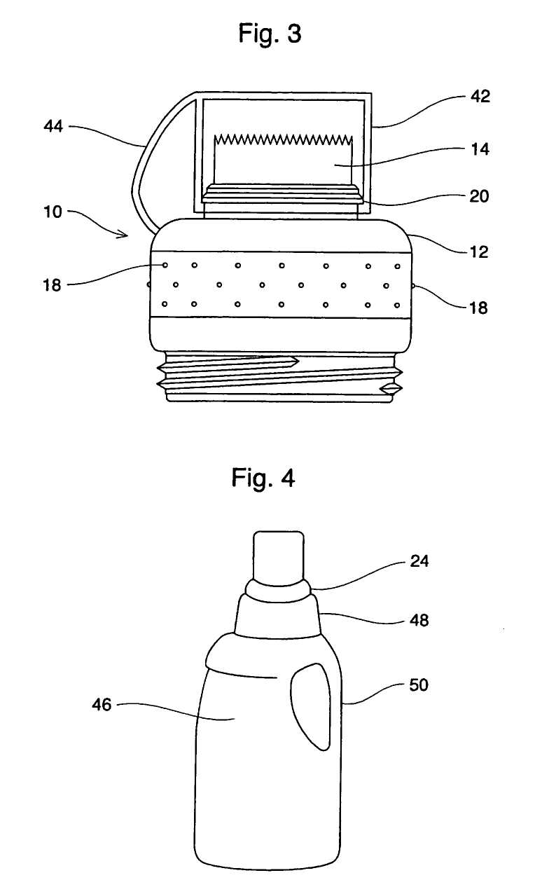

Referring to the figures, in FIG. 1, a preferred container, 10, is illustrated having a hollow body member, 12, which is operatively joined to an applicator, 14, which in this case is a ball-type applicator. As used herein, “operatively joined” indicates that the interior of the hollow body member is joined to the applicator in such a manner as to allow, during use, cleaning composition inside of the hollow body member to flow to the applicator and thereby to be applied to the desired surface. The hollow body member, 12, has an attachment portion, 16, which removably attaches to a measuring implement (see FIG. 2 at 24) during use. To facilitate gripping and use, the container, 10, has a plurality of right-handed ergonomic grips, 18, formed into the side of the hollow body member, 12. To reduce messiness after use, the hollow body member, 12, has a fitment, 20, to which an applicator cover (see FIG. 3 at 36) may be attached.

Preferred container materials include plastics and polymers, rubber, glass, metal, and combinations thereof. More preferred container materials include rubber, plastic, polyesters, and combinations thereof, and even more preferred container materials include polyethylene, polypropylene, polyethylene terephthalate, polycarbonate, polystyrene, ethyl vinyl alcohol, thermoplastic elastomer, and combinations thereof. Flexible container parts preferably contain at least a portion of thermoplastic elastomer, whereas preferred ergonomic grips are made of rubber and/or non-slippery plastic so as to enhance gripping during use and/or reduce noise when placed in a washer/dryer. Textured surfaces may also be employed so as to enhance gripping, if desired. Preferred production processes are blow molding, injection molding, injection blow molding, vacuum forming, thermoforming, and combinations thereof. The various individual container portions may be formed with different materials, and/or by different processes, as desired. Optional, but preferred characteristics of the container material include color, tinting, translucency, transparency, or opaqueness. Other characteristics include easy formation to the desired shape(s), resistance to cleaning compositions/solutions and applicable pH ranges, durability, coloration, coatings and/or resiliency to allow the container to be added to the wash and/or drying cycle without causing undue noise. If the container material is transparent or translucent, the user may visibly gauge the level of detergent composition and/or solvent contained therein. If the container (or a part thereof) is to be placed inside a machine wash cycle, then the container material should be temperature resistant to machine-washing temperatures, i.e., typically from about 5° C. to about 90° C. Ideally, the container material selected should be resistant to temperatures ranging from below freezing up to above the temperatures at which clothes dryers operate. These preferred ranges may be relevant, for example, where consumers store cleaning supplies outside during the winter, and where the container may be transferred, either intentionally or unintentionally, into a clothes dryer.

If intended as a laundry pretreatment device for use with a liquid detergent composition, the hollow body member, 12, typically has an overflow volume of from about 0.5 mL to about 200 mL, preferably from about 1.0 mL to about 100 mL, and more preferably from about 3 mL to about 80 mL. As used herein, the overflow volume is measured by plugging any apertures and filling the container, without the measuring implement attached, with water until full. However, it is recognized and intended that if the container is attached to the measuring implement, then the total interior volume defined by the combination of the measuring implement and the container may be greater than the described range. Such an interior volume allows a typical laundry user to employ the container to pretreat approximately 1 typical load of laundry items when attached to a measuring implement such as a measuring cap.

The container, 10, and more particularly the hollow body member, 12, should be formed in a variety of shapes and sizes that allow the container to be easily, comfortably, and conveniently held in one hand. This significantly increases the ease of use of the container, and also reduces the storage space needed when it is not in use. The cross-sectional shape of the container may be any shape which is comfortable to be held in the hand, but is preferably an oval, round, triangular, and/or square shape with rounded and/or soft edges. Preferably, the container's length is from about 30 mm to about 100 mm, while the width is from about 30 mm to about 70 mm, and the height is from about 30 mm to about 60 mm. Furthermore, when clean and empty, the container preferably weighs less than about 100 g, preferably from about 10 g to about 50 g.

The applicator, 14, applies the cleaning composition to the surface to be cleaned, and is preferably associated with at least one aperture, 22, such that when the cleaning composition exits the aperture, it immediately commingles with the applicator, 14, to allow neat, convenient, accurate, and easy application of the cleaning composition to the surface to be cleaned. Nonlimiting examples of the applicator useful herein includes a brush, a roller ball, a sponge, a nozzle, a slit, bristles, rubbing nubs/bumps/ridges, a scrubbing surface, and a combination thereof, of which a brush, a ball-type applicator, a pump-sprayer, rubbing nubs/bumps/ridges and a combination thereof are preferred. It is preferred that at least one applicator be utilized herein, more preferably one or two applicators.

If the applicator includes a brush or bristles, the brush/bristle strength and length may be tailored to the type of cleaning to be performed. For example, in cleaning fabrics, bristles which are too stiff or sharp may harm fabrics to be cleaned, especially delicate fabrics such as silk. Accordingly, either longer bristles, softer bristles, and/or bristles having a blunted tip and/or edges are preferred. For fabrics, preferred brushes have a bristle strength of less than about 200 N/cm², preferably less than about 150 N/cm². Bristle strength is measured using the method of JIS S 3016, except that a press head speed of 12.5 mm/min, and a bristle area of about 5.5 cm² are used; JIS S 3016 is a Japanese Industrial Standard for measuring toothbrush bristle strength. The compression testing machine used herein is a Compression Tester, model YLM-5, made by Toyo Tester of Osaka, Japan. For non-fabric cleaning applications, or for pretreating less sensitive surfaces, stiffer bristles may be desirable.

Ball-type applicators and other applicators useful herein include those described in, for example, EP 712 592 A1 to Poolman, et al., published on May 22, 1996; U.S. Pat. No. 5,887,753 to Poolman, issued on Mar. 30, 1999; EP 931 870 A1 to DeFlander, et al., published on Jul. 28, 1999; U.S. Pat. No. 5,971,645 to Fukushima, et al., granted on Oct. 26, 1999; and WO 00/20676 A1 to Taneko and Fukushima published on Apr. 13, 2000.

Pump-sprayers useful herein include all pump-type dispensers known in the art, especially piston-type and trigger-type pump-sprayers. Such pump-sprayers are available from many packaging suppliers, such as, for example, Yoshino Kogyosho Co., Ltd., Tokyo, Japan and/or may be easily adapted to the hollow body member herein by one skilled in the art.

Other preferred applicators include, for example, elastic, rubber, or plastic pads of any convenient shape, such as a circle, an oval, a square, etc., having one or more rubbing nubs, bumps, ridges, etc., of the same or different sizes. Such rubbing nubs, bumps, and/or ridges are typically less than about 2 cm, preferably from about 0.1 mm to about 7 mm, more preferably from about 0.2 mm to about 3 mm in height, and preferably should not contain any sharp edges which could be possibly perceived as causing fabric damage. If multiple ridges are employed, they may be arranged as concentric or intersecting circles, squares, ovals, or other geometric figures. In a preferred embodiment, the ridges are arranged as a series of non-intersecting wavy lines.

The applicator may be formed of any of the container materials described above as useful for the container, but may also be formed of a nonwovern material, an abrasive material, a plastic material, a cloth material, a polymeric material, a resin material, a foam rubber material, a natural or artificial sponge, a functional absorbent material (FAM), a polyurethane foam, and/or of any other material known in the container art. Preferably, the FAM herein has an absorbent ability of more than about 20 g H₂O/g, more preferably, 40 g H₂O/g by weight of FAM, such as described in U.S. Pat. No. 5,260,345 to DesMarais, et al., issued on Nov. 9, 1993 and U.S. Pat. No. 5,889,893 to Dyer, et al., issued on May 4, 1999.

If desired, the applicator, 14, and/or the aperture, 22, may be angled relative to the hollow body member, 12, so as to form an aperture angle (not shown). This may allow easier and more ergonomic use of the applicator; a further explanation of the aperture angle useful herein may be found in, for example, WO 01/21499 A1 to Silud and Ng, published on Mar. 29, 2001.

FIG. 2 shows a cut-away view of the container, 10, of FIG. 1, as seen along line 2-2, further including a measuring implement, 24, attached to the hollow body member, 12. In FIG. 2, the hollow body member, 12, and the measuring implement, 24, showed herein as a measuring cap, screw together at the attachment portion, 16, to form a seal, 26. To removably attach the measuring cap and the container, it is highly preferred that a screw-type attachment portion be employed. In such a case, it is highly preferred that the screw pitch and size of the attachment portion match that of the detergent container, preferably a detergent bottle, so as to facilitate easy use and attachment of the container to the measuring cap.

The measuring cap, 24, has a plurality of measuring indicators, 28. While the measuring indicators, 28, in FIG. 2 are indicated as slight protrusions on the interior of the measuring cap, 24, such measuring indicators may also be formed by other means known in the art, such as printing directly onto the measuring implement, silk screening the measuring implement, forming indentations or protrusions in the measuring implement, hot stamping, and a combination thereof, in the interior and/or on the exterior, as desired. Such measuring indicators are preferably aligned in either a horizontal or vertical direction. Similarly, other indicators such as a logo, brand name, trade name, etc. may also be applied to the measuring implement, the detergent container, and/or the container herein by similar methods known in the art.

The ball-type applicator, 14, is supported by a support, 30, which urges the ball-type applicator, 14, to form a breakable seal, 26, with the aperture, 22. In FIG. 2, the preferred support, 30, has a plurality of deformable arms, 32, which are angled to increase their resiliency. The support is both flexible and resilient so as to form the breakable seal, 26. When pressure is exerted from the exterior onto the ball-type applicator, 14, during use, the support allows the ball-type applicator, 14, to depress, thereby allowing the cleaning composition to flow out of the aperture, 22, and along the ball-type applicator, 14, to be deposited onto the surface. The interrupted rim, 34, prevents the ball-type applicator, 14, from being pushed too far into the container, but at the same time, allows the cleaning composition to flow past during use. A preferred ball-type applicator, aperture, support, and interrupted rim useful herein is shown in FIG. 2b and FIG. 3 of EP 712 592 A1 to Poolman, et al., published on May 22, 1996.

The attachment portion and the measuring implement may removably attach together according to any method known in the art; however, the attachment method must be reversible, in that the user must be able to repeatedly remove and re-attach the attachment portion to the measuring implement. Accordingly, the attachment portion has a non-permanent attachment method, such as an elastic fitment, a releasable lock, a screw, and/or a releasable snap. The elastic fitment useful herein may employ, for example, a rubber ring or strap on the hollow body member which stretches to accommodate the corresponding portion of the measuring implement. Alternatively, the elastic fitment may be located on the measuring implement, and removably attach to the attachment portion. Similarly, a preferred releasable lock, screw, or releasable snap known in the art may be located on either the attachment portion or the corresponding area of measuring implement, as desired. When the attachment portion, 16, and the measuring implement, 24, are properly attached together for use, the seal, 26, should be impermeable to the cleaning composition to be contained therein. Preferably the seal is a water-tight seal. If present, water-tight seals and/or cleaning composition-tight seals may be formed by employing permanent or replaceable washers, and/or by other means, known in the art.

The measuring implement useful herein is preferably a measuring cap which attaches to a liquid detergent composition bottle, but may also be, for example, a measuring cup. In FIG. 2, the measuring cap, 24, is a “double-walled” measuring cap having an internal screw thread-type attachment portion, 16, as shown in FIG. 2, or may be a simple single-walled measuring cap with a screw thread or snap-type closure. Alternatively, a snap-fit closure and/or a friction-fit closure may also be employed. In the preferred embodiment of FIG. 2, the interior edge, 36, of the double-walled measuring cap, 24, contacts an optional inner lip, 38, of the container, 10, to form a water-tight seal, 26. This prevents the cleaning composition from contacting the edges of the exterior cavity, 40, during use. It is believed that this optional but highly preferred feature serves to significantly reduce messiness and increase consumer acceptance during use.

If, as in FIG. 3, cleaning composition is not intended to enter the exterior cavity, 40, then such a volume is not included in any measurements of the container's overflow volume. However, if an exterior cavity is present into which cleaning composition is intended to enter, then the exterior cavity is included in any measurements of the container's overflow volume.

FIG. 3 shows a preferred container, 10, with an applicator cover, 42, removably attached to the hollow body member, 12, by the fitment, 20. In FIG. 3, the fitment, 20, is merely a raised ridge onto which the applicator cover, 42, snaps to protect the applicator, 14. In FIG. 2, the applicator, 14, is a plastic brush for scrubbing the surface and the applicator cover, 42, is formed of clear plastic. To further reduce messiness, the aperture cover, 36, and the fitment, 20, form a seal, 26, which is preferably impermeable to the cleaning composition. A thin, flexible filament, 44, permanently attaches the aperture cover, 42, to the container, 10 to prevent loss of the aperture cover, 42. Other methods, such as hinges, releasable locks, etc. may also be used to attach the applicator cover to the container and/or the hollow body member. An aperture (not shown) for dispensing the cleaning composition is preferably located in the center of the brush to allow easy and accurate dispensing and scrubbing. Preferably, a valve is attached to the aperture to help regulate flow of the cleaning composition.

FIG. 3 also shows a neutral ergonomic grip, 18, formed of a textured rubber surface having a plurality of small bumps to reduce slippage during use. The container, and more specifically, the ergonomic grip, may be formed for right-handed use, left-handed use, or “neutral”, i.e., for use in either hand, as preferred. This is preferably accomplished by forming protrusions and/or indentations which correspond to locations where the user's fingers and hand will most comfortably grip and hold the container during use.

FIG. 4 shows a side view of a detergent container, 46, and a measuring implement, 24, here a measuring cap. The measuring implement, 24, is a double-walled measuring cap which removably screws onto a transition piece, 48, which is permanently attached to the detergent container, 46. The detergent container is formed of recyclable plastic and has a handle, 50, integrally formed thereupon.

The cleaning composition useful herein is generally a laundry detergent composition or a hard surface cleaning composition, preferably a liquid laundry detergent composition, but may also be, for example, a bleaching composition, or a spot removing composition. In addition, the cleaning composition is typically, but not necessarily, a liquid or gel detergent composition; although granular and paste detergent compositions may be used with the container herein they are not preferred. Cleaning compositions useful herein include those described in, for example, U.S. Pat. No. 5,496,487 to Capeci, et al., issued on Mar. 5, 1996; U.S. Pat. No. 4,963,226 to Chamberlain, issued on Oct. 16, 1990; and U.S. Pat. No. 4,129,511 to Ogoshi, et al., issued on Dec. 12, 1978. See also, WO 95/33044 to Vinson, et al., published on Dec. 7, 1995; WO 99/09126 to Bettiol, et al., published on Feb. 25, 1999; PCT Patent Application No. U.S. 00/00839 to Showell, et al., filed on Jan. 13, 2000; U.S. Pat. No. 5,916,862 to Morelli, et al., issued on Jun. 29, 1999; U.S. Pat. No. 5,565,145 to Watson, et al., issued on Oct. 15, 1996; U.S. Pat. No. 5,470,507 to Fredj, et al., issued on Nov. 28, 1995; U.S. Pat. No. 5,466,802 to Panadiker, et al., issued on Nov. 14, 1995; U.S. Pat. No. 5,460,752 to Fredj, et al., issued on Oct. 24, 1995; U.S. Pat. No. 5,458,810 to Fredj, et al., issued on Oct. 17, 1995; U.S. Pat. No. 5,458,809 to Fredj, et al., issued on Oct. 17, 1995; U.S. Pat. No. 5,559,090 to Scialla and Cardola, issued on Sep. 24, 1996; U.S. Pat. No. 5,536,438 to Scialla, et al., issued on Jul. 16, 1996; WO 95/21122 to Rapisarda, et al., published on Aug. 10, 1995; U.S. Pat. No. 6,037,317 to Rapisarda, et al., issued on Mar. 14, 2000; WO 95/34621 to Scialla, et al., published on Dec. 21, 1995; and U.S. Pat. No. 5,929,012 to Del Duca, et al., issued on Jul. 29, 1999.

Such a cleaning composition will be contained within a detergent container such as a bottle, a box, a bag, etc., as is appropriate, typically, a detergent bottle, having a measuring implement such as a measuring scoop, a measuring cup, a measuring cap, and/or another type of dosing device, preferably a measuring cap. Examples of preferred detergent containers and/or measuring implements useful herein include those described in EP 369 560 A1 to Mon, published on May 23, 1990; U.S. Pat. No. 4,773,560 to Kittscher, issued on Sep. 27, 1988; GB Design Patent 2 098 034 to Yamane, et al., granted on Nov. 29, 2001; GB Design Patent No. 2 105 604 to Yamane, et al., granted on Nov. 29, 2001; WO 01/19598 A1 to Johnson, et al., published on Mar. 22, 2001; WO 01/19692 A1 to Johnson, et al., published on Mar. 22, 2001; EP 1 176 100 Al to Johnson, et al., published on Jan. 30, 2002; U.S. patent application Ser. No. 10/093,043 to Etesse, filed on Mar. 7, 2002; and (Kao bottle). Detergent containers containing the combination of a “double-walled measuring cap” and a “self-draining spout” as described in EP 369 560 A1, above, are especially preferred.

The flow rate of the cleaning composition may be regulated by a variety of methods known in the art, such as applying hand pressure to a squeezable applicator, hollow body member and/or measuring implement during use, employing a pump-sprayer, a one-way or two-way valve, gravity-aided flow, adjusting the size of the aperture and the viscosity of the cleaning composition, etc. Such methods are well known in the art.

Furthermore, for convenient storage, the container herein may designed to stably rest on and/or removably attach, either directly or indirectly, to the detergent container, measuring implement, measuring cap, etc. by, for example, hanging around the neck or handle of the detergent bottle via the thin, flexible filament. In a preferred embodiment, the attachment portion may be sized such that it securely fits over the top of the measuring cap when the measuring cap is screwed onto the detergent bottle.

To help a user easily understand the use of the new container herein, it is highly preferred that the container be provided with an instruction set containing a recommendation to measure the cleaning composition with the measuring implement, a recommendation to attach the container to the measuring implement, and to pretreat a surface, preferably a fabric, with the applicator. Such an instruction set may also contain additional recommendations, for example, to remove the applicator cover prior to use, to clean the container by removing it from the measuring implement and then adding it to the wash cycle, etc.

### EXAMPLE 1

A container is formed of translucent high density polypropylene according to FIG. 1 and FIG. 2. The ergonomic grip is designed for right-handed use and is formed of soft polyethylene to reduce noise in the washing machine and/or dryer. The container has an overflow volume of 35 mL, and tightly and reversibly screws onto a double-walled measuring cap, as shown in FIG. 2, forming a water-tight seal between both the matching screw threads of the measuring cap/container, as well as between the inner lip of the container and the interior edge of the measuring cap. A clear applicator cover is also provided which is removably attached to the hollow body member, near the rollerball-type applicator, by a snap-type fitment. Furthermore, to prevent loss of the aperture cover, a thin, flexible plastic filament permanently joins the aperture cover and the container.

The container is packaged together with a detergent bottle, as seen in FIG. 4, containing a liquid laundry detergent. As the screw pitch and size are the same for both the container and the detergent bottle, the measuring cap also screws onto the detergent bottle to form a water-tight seal. The liquid detergent is intended for use in an automatic laundry machine.

To use the container, the instruction set recommends that the user first measure the appropriate amount of laundry detergent into the measuring cap, as instructed on the bottle. The user should then attach the container to the measuring implement via the attachment portion, and remove the applicator cover to reveal the applicator. The user should then invert the container into a dispensing position and slightly depress the rollerball against a fabric to start the liquid detergent flowing through the aperture and around the surface of the rollerball to the fabric. The rollerball should then be rolled along the fabric to pretreat a stain and/or the desired location on the fabric. Pressure may be applied intermittently, to a varying degree, and/or constantly to keep the desired amount of detergent composition flowing to the rollerball. When pretreatment is finished, the container should be removed from the measuring cap and added to the wash cycle for cleaning. The measuring cap should be replaced onto the detergent bottle for storage.

### EXAMPLE 2

A container is formed according to Example 1, except that the rollerball is replaced with the brush of FIG. 3. The container is formed of polypropylene and the brush is formed of polyethylene and has a bristle strength of 50 N/cm².

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A container for attaching to a measuring implement and for applying a cleaning composition to a surface, said container comprising:
(A) an applicator;
(B) a hollow body member operatively joined to the applicator; and
(C) an attachment portion joined to the hollow body member;
wherein the attachment portion removably attaches to the measuring implement, and wherein when the applicator is in a dispensing position and when the hollow body member comprises therein the cleaning composition, the cleaning composition is dispensed by the applicator to the surface.

2. The container according to claim 1, wherein the applicator is selected from the group consisting of a brush, a ball-type applicator, a pump-sprayer, rubbing nubs/bumps/ridges and a combination thereof.

3. The container according to claim 1, further comprising an applicator cover removably attached to the hollow body member.

4. A cleaning kit comprising:
(A) a detergent container comprising therein a cleaning composition;
(B) a measuring implement; and
(C) a container according to claim 1.

5. A cleaning kit according to claim 4, wherein the attachment portion is selected from the group consisting of an elastic fitment, a lock, a screw, a snap, and a combination thereof.

6. A cleaning kit according to claim 4, wherein the attachment portion and the measuring implement form a seal, wherein the seal is impermeable to the cleaning composition.

7. A cleaning kit according to claim 4, further comprising an instruction set comprising a recommendation to treat at least a portion of the surface with the applicator.

8. A cleaning kit according to claim 4, wherein the cleaning composition is a liquid or a gel detergent composition.

9. A method for cleaning a surface comprising the steps of:
(A) measuring a predetermined amount of a cleaning composition in a measuring implement;
(B) attaching a container according to claim 1 to the measuring implement;
(C) dispensing the cleaning composition to the surface via the applicator; and
(D) rinsing the surface with water to remove the cleaning composition.

10. A container for attaching to a measuring implement and for applying a liquid detergent composition to a surface comprising:
(A) an applicator selected from the group consisting of a brush, a ball-type applicator, a pump-sprayer, rubbing nubs/bumps/ridges and a combination thereof;
(B) a hollow body member operatively joined to the applicator;
(C) an applicator cover removably attached to the hollow body member; and
(D) an attachment portion joined to the hollow body member, therein the attachment portion is selected from the group consisting of an elastic fitment, a lock, a screw, a snap, and a combination thereof;
wherein the attachment portion removably attaches to the measuring implement to form a seal, wherein the seal is impermeable to the cleaning composition, and wherein when the applicator is in a dispensing position and when the hollow body member comprises therein the liquid detergent composition, the cleaning composition is dispensed by the applicator to the surface.
